(19) United States
(12) Patent Application Publication
(10) Pub. No.: US 2020/0263042 A1
(43) Pub. Date: Aug. 20, 2020

(54) Intumescent Coating with Reinforcement Mesh

(71) Applicant: United States Mineral Products Company, Stanhope, NJ (US)

(72) Inventor: Robert Paul Kreh, Middle River, MD (US)

(73) Assignee: United States Mineral Products Company, Stanhope, NJ (US)

(21) Appl. No.: 16/870,092

(22) Filed: May 8, 2020

Related U.S. Application Data
(63) Continuation-in-part of application No. 16/535,682, filed on Aug. 8, 2019.
Application No. 16/535,682 is a division of application No. 14/604,978, filed on Jan. 26, 2015, now abandoned.
Application No. 14/604,978 is a continuation-in-part of application No. 14/568,212, filed on Dec. 12, 2014, now abandoned.

(51) Int. Cl. C09D 5/18; C09D 163/00; B32B 15/18; B32B 21/08; B32B 15/20; C08K 3/016; B32B 15/08; B32B 27/38; B32B 27/10; C08K 5/00; B32B 7/12; B32B 27/12; B32B 5/02

(52) U.S. Cl. CPC C09D 5/185; C09D 163/00; B32B 15/18; B32B 21/08; B32B 15/20; C08K 3/016; C08K 3/38; B32B 27/38; B32B 27/10; C08K 5/0066; B32B 7/12; B32B 27/12; B32B 5/028; B32B 15/08

(57) ABSTRACT

The present disclosure relates to intumescent fireproofing coatings and methods to apply these coatings. In particular, the disclosure relates to an intumescent composition having a first epoxy resin layer containing a first intumescent material and a reinforcement mesh, wherein the reinforcement mesh has an adhesive applied to only one surface thereof. After the reinforcement mesh/adhesive is applied to the first epoxy resin layer, a second epoxy resin layer containing a second intumescent material is generally applied thereon.

### CROSS REFERENCE TO RELATED APPLICATIONS

The present application is a continuation-in-part of co-pending U.S. patent application Ser. No. 16/535,682, filed Aug. 8, 2019, which claims priority benefit to U.S. patent application Ser. No. 14/568,212, filed Dec. 12, 2014, and to U.S. patent application Ser. No. 14/604,978, filed Jan. 26, 2015. This application claims priority benefit to the foregoing applications and hereby incorporates by reference the foregoing application in their entireties as part of the present disclosure.

### FIELD OF THE TECHNOLOGY

The present disclosure relates to intumescent fireproofing coatings and methods to apply these coatings and associated reinforcement mesh. In particular, the disclosure relates to epoxy-based intumescent fireproofing coatings and mesh reinforcements, wherein the mesh reinforcement is affixed to the epoxy-based intumescent coating after applying an adhesive substantially to one surface of the mesh reinforcement.

### BACKGROUND

Fireproofing is used in a variety of construction settings to provide fire retardation and/or thermal protection in the event of a fire. A variety of combustible or heat sensitive substrates are protected by fireproofing. Examples are wood, foam insulation, structural steel, walls and floors.

One type of fireproofing is an intumescent coating wherein, during a fire, the coating swells and forms a fire-stable insulating foam “char.” The intumescent coating can be based on a variety of different resin types, such as polyvinylacetate, polyacrylate, polyurethanes and epoxy resins. Epoxy-based intumescent coatings are often employed to provide superior stability to environmental challenges, such as rain, salt water, temperature extremes and physical abuse. In addition, epoxy-based intumescent coatings form strong chars during a fire, providing resistance to very high temperatures, flame erosion and char sagging. For example, these coatings can provide fireproof protection for fires with fast, extreme temperature rises and strong, eroding flames (e.g., the UL 1709 standard and “jet fire”). These types of fires have been known to occur at petrochemical plants, gas storage facilities and off-shore oil facilities. These coatings can also provide fireproof protection for milder fires fueled by cellulosics or plastics. Standard evaluation of fireproofing can be done using the ASTM E119 standard.

While epoxy-based intumescent coatings can form strong, durable chars, these chars can be brittle, leading to cracks and fissures within the char. If these defects widen and extend down to the substrate, the insulation can be compromised, resulting in a fast temperature rise of the substrate. This is especially problematic on round substrates and at “outer” edges of substrates. For example, intumescent coatings are prone to failure at the corners of rectangular substrates and on the tips of wide-flange columns or beams.

To address this problem, a common solution is the placement of high-temperature-resistant mesh within the epoxy coating. Examples of mesh materials include metal wire mesh, glass fiber mesh, sintered/pyrolyzed carbon fiber mesh and refractory mineral fiber mesh (e.g., basalt). The mesh is generally placed at a depth of ⅓-⅔ of the total thickness of the coating. During a fire, as char-splitting moves downward through the fireproofing toward the substrate, it can be halted by the mesh, preventing the lower char from splitting. A degree of insulation can be maintained at these char splits where the mesh is present.

As noted above, the mesh is usually placed near the middle of the fireproofing (e.g., at a ⅓-⅔ depth) to prevent direct exposure of the mesh to the heat. It is also placed in the middle to allow the upper, outer fireproofing to experience char growth unrestricted by the mesh. The char expansion underneath the mesh is generally less than that above the mesh.

U.S. Pat. No. 5,433,991, incorporated herein by reference in its entirety, describes traditional embedding of mesh installation in an epoxy fireproofing layer. By embedding the mesh, the mesh is adhered to and encapsulated into an epoxy-intumescent material. This avoids the introduction of “foreign” material, or a second fireproofing material, in contact with the mesh which could result in deleterious effects, such as delamination or slippage between layers either before or during a fire. Also, the introduction of two different chemistries within the fireproofing, or in contact with the mesh, can have adverse effects on curing and/or the chemical/physical reactions necessary for intumescence.

The typical procedure for applying an intumescent fireproofing coating having a mesh is known. After application of a lower layer of uncured epoxy material, a period of time is allowed to pass, during which the lower layer “gels.” The mesh is applied while the viscosity is still low enough such that the one mesh can be pushed into the lower later of epoxy material, but high enough such that the mesh can be pushed into the lower layer of epoxy material, but high enough to avoid excessive deformation of the partially cured epoxy layer or the mesh. At the same time, the viscosity is low enough such that the mesh will penetrate the partially-cured layer. Ensuring the proper timing of this step is burdensome to the applicator and varies with the materials used and the environmental conditions. Sufficient embedment and leveling of the surface is also needed. This is generally accomplished by rolling the mesh/epoxy surface with a solvent-soaked “painting” roller. Solvent is used to prevent the sticking of the partially-cured epoxy to the surface of the roller. A highly volatile (and flammable) solvent, such as acetone, is used so that it will evaporate prior to application of the next epoxy layer (usually several hours later). Managing this timing presents an additional burden on the applicator. The release of solvent vapors is also undesirable due to potentially adverse effects to worker health and to the environment.

The present disclosure relates to intumescent fireproofing coating compositions that include reinforcement meshes, kits, and methods of applying the same. The coating compositions are safe, environmentally friendly, less cumbersome to apply, and perform as well as, or better, than known coatings.

### SUMMARY

The present disclosure relates to intumescent fireproofing coating compositions that include reinforcement meshes, kits, and methods of applying the same.

In one embodiment, the present disclosure relates to an intumescent composition having a first epoxy resin layer containing a first intumescent material and a reinforcement mesh, wherein the reinforcement mesh has an adhesive applied substantially to one surface thereof. After the reinforcement mesh/adhesive is applied to the first epoxy resin layer, a second epoxy resin layer containing a second intumescent material is generally applied thereon. Once the installation is complete, the first and second epoxy resin layers provide intumescent materials that swell as a result of heat exposure. The overall intumescent composition, i.e., the first epoxy resin layer, the reinforcement mesh with adhesive applied to one side thereof, and the second epoxy resin—can be applied as a fireproofing coating to a substrate. It is understood that the first and second intumescent materials can be the same or different. It is understood that the first and second epoxy resins can be the same or different. It is understood that the layers referred to above can be comprised of sub-layers, each being identical or different and may contain one or more mesh layers—in addition to the reinforcement mesh with adhesive applied to one surface thereof.

In another embodiment, the present disclosure relates to a method of applying a first epoxy resin layer containing a first intumescent material to a substrate, applying an adhesive substantially to one surface of a reinforcement mesh, applying the reinforcement mesh to the first epoxy resin layer with the applied adhesive layer directed toward the first epoxy resin layer, and applying a second resin layer containing a second intumescent material over the reinforcement mesh to form an intumescent composition. The first and second epoxy resin layers containing intumescent materials swell as a result of heat exposure. It is understood that the first and second intumescent materials can be the same or different. It is understood that the first and second epoxy resins can be the same or different. It is understood that the layers referred to above can be comprised of sub-layers, each being identical or different and may contain one or more mesh layers—in addition to the reinforcement mesh with adhesive applied to one surface thereof.

Additional features, functions and benefits associated with the present disclosure will be apparent from the detailed description which follows.

### DETAILED DESCRIPTION

It is one object of the present disclosure to provide a straightforward and safe method for the application of reinforcement mesh within an epoxy intumescent coating. The application of the reinforcement mesh is accomplished using an adhesive which is applied substantially to one surface of the reinforcement mesh. The adhesive generally takes the form of a thin layer of adhesive by which to hold the mesh in place on a first epoxy resin/intumescent layer until application of the next epoxy resin/intumescent layer. The mesh attachment can be carried out any time between application of the first layer (e.g., lower epoxy-intumescent layer), or preferably after sufficient curing of the first layer occurs, or more preferably just before application of the second layer (e.g., upper epoxy-intumescent layer). By attaching the mesh using an adhesive applied substantially to one surface thereof, the need to properly time the mesh application to the first epoxy-intumescent layer is significantly reduced or eliminated, as well as the other problems associated with applying the mesh. In addition, the adhesive is isolated (or substantially isolated) from the exposed surface of the first epoxy resin layer/reinforcement mesh combination, thereby eliminating or substantially reducing the potential for adhesive to undesirably interact with and/or foul a roller used to press and/or smooth the reinforcement mesh into or relative to the first epoxy resin layer.

As used herein, the term “intumescent composition” refers to a composition that contains an intumescent material.

As used herein, the term “layer” means a thickness of epoxy resin and intumescent material having a homogeneous composition that is separately formed from other layers. Each of the layers of the multilayer composition of the present disclosure may have the same or different widths and thicknesses. The epoxy resin and intumescent material of the different layers may be identical or different.

As used herein, the term “intumescent material” means a material that expands, foams, or swells when exposed to a sufficient amount of thermal energy.

In one embodiment, the present disclosure relates to an intumescent composition having a first epoxy resin layer containing a first intumescent material and a reinforcement mesh, wherein the reinforcement mesh has an adhesive applied substantially to one surface thereof. After the reinforcement mesh/adhesive is applied to the first epoxy resin layer, a second epoxy resin layer containing a second intumescent material is generally applied thereon. Once the installation is complete, the first and second epoxy resin layers provide intumescent materials that swell as a result of heat exposure.

The overall intumescent composition, i.e., the first epoxy resin layer, the reinforcement mesh with adhesive applied to one side thereof, and the second epoxy resin—can be applied as a fireproofing coating to a substrate in need of fire retardation and/or thermal protection in the event of a fire. The thickness of this first epoxy resin/intumescent layer may vary depending on the substrate, the resin, the intumescent material and the degree of protection desired. In one embodiment, this first layer can have a dry film thickness between about 0.5 mm and about 20 mm. More particularly, the first resin layer can have a dry film thickness between about 1 mm and about 10 mm, or about 2 mm and about 6 mm. In some embodiments, the dry film thickness can be about 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm and 20 mm. These values can also be used to define a range of thicknesses, e.g., about 2 mm to about 10 mm.

The thickness of the first epoxy resin/intumescent layer can be consistent throughout the composition. For example, the variation of the thickness of the first resin layer over a substrate or a substrate section can vary less than about 5% or about 10%. In some embodiments, this first layer can also have an inconsistent thickness. Similarly, this first layer can be continuous over a substrate or a substrate section. In some embodiments, the first resin layer can also be non-continuous. For example, a first epoxy resin/intumescent layer on a flat surface can be continuous, have a consistent thickness, or both. In another example, this first resin layer on an uneven surface can be non-continuous, have a variable thickness, or both. The second epoxy resin/intumescent layer can also have the same thickness variations and continuous features.

The epoxy resin used for the first and second epoxy resin/intumescent layers can be independently selected from resins known to one skilled in the art that are used in epoxy intumescent compositions. In a preferred embodiment, the epoxy resin is two part, with curing taking place after it is applied to a substrate. One part has epoxy functionality, while the other part reacts with said epoxy. This second part is often referred to as a hardener. In a preferred embodiment, the hardener is comprised of one or more chemicals with amine functionality. In a preferred embodiment, the epoxy contains one or more chemicals for viscosity reduction.

The first and second resin layers can also have the same epoxy resin. In one embodiment, the first and second epoxy resin/intumescent layers can also contain different resins.

The amount of first resin layer in the composition can vary depending on the substrate, the resin, the intumescent material and the degree of protection desired. In one embodiment, the amount of first resin layer in the composition can be between about 10 wt % and about 90 wt %. More particularly, the amount of first resin layer in the composition can be between about 30 wt % and 70 wt %. In some embodiments, the amount of the first resin layer can be about 10, 15, 20, 25, 30, 35, 40, 45, 50, 55, 60, 65, 70, 75, 80, 85 or 90 wt %. These values can also be used to define a range of amounts, e.g., about 25 wt % to about 65 wt %.

Likewise, the amount of second resin layer in the composition can vary depending on the substrate, the resin, the intumescent material and the degree of protection desired. In one embodiment, the amount of second resin layer in the composition can be between about 10 wt % and about 90 wt %. More particularly, the amount of second resin layer in the composition can be between about 30 wt % and 70 wt %. In some embodiments, the amount of the second resin layer can be about 10, 15, 20, 25, 30, 35, 40, 45, 50, 55, 60, 65, 70, 75, 80, 85 or 90 wt %. These values can also be used to define a range of amounts, e.g., about 25 wt % to about 65 wt %. It is understood that the layers referred to above can be comprised of sub-layers, each being identical or different and may contain one or more mesh layers.

The first and second resin layers each independently contain an intumescent material. The intumescent material imparts on the resultant intumescent resin layer, and the composition, with the ability to swell when exposed to heat. The intumescent materials can be independently selected from intumescent materials known in the art and, in particular, the group consisting of ammonium polyphosphate, melamine pyrophosphate, ethylenediamine phosphate, boric acid, limestone, titania, mineral solids, ceramic solids, glass solids, fibers, phosphate esters, borates, silica, melamine, tris(hydroxyethyl) isocyanurate, clays, polyhydroxy organic chemicals, carbon, expanded graphite, benzyl alcohol, alumina, phenols, polysulfides, tris(dimethylaminomethyl)phenol and similar chemicals.

The amount of intumescent material in either the first or second resin layer can vary depending on the substrate, the resin, the intumescent material and the degree of protection desired. In one embodiment, the amount of intumescent material independently in either the first or second resin layer can be between about 20 wt % and 80 wt %. More particularly, the amount of intumescent material independently in either the first or second resin layer can be between about 30 wt % and 70 wt %. In some embodiments, the amount of the intumescent material independently in either layer can be about 5, 10, 15, 20, 25, 30, 35, 40, 45, 50, 55, 60, 65, 70, 75 and 80 wt %. These values can also be used to define a range of amounts, e.g., about 5 wt % to about 35 wt %.

Suitable resin-intumescent materials (i.e., a resin containing an intumescent material) are known in the art. For example, epoxy-intumescent materials are known in the art, such as NanoChar, CHARTEK™ VII, Pyroclad Xl, Pittchar and Firetex M90. These suitable resin-intumescent materials typically consist of a two-part system. For instance, a two part epoxy system is described: a first part being an epoxy resin (binder) plus additives, and a second part being a hardener plus additives. The two parts are mixed and used to coat the substrate. In some embodiments, the first resin layer containing a first intumescent material, the second resin layer containing a second intumescent material, or both are selected from these suitable resin-intumescent materials. Additional examples of suitable resin-intumescent materials are described in U.S. Pat. Nos. 6,069,812 and 5,070,119, each incorporated herein by reference in its entirety.

The first and second resin layers can be applied by known techniques. In particular, the first and second resin layers can be applied by spray, trowel, brush and by similar means. In some instances, the suitable resin-intumescent material is applied and cures after application. The cure time can vary. Typical cures times are between about 1 hr and 24 hr. For high-viscosity compositions, fast curing resin layers (e.g., between about 1 hr and 6 hr) or when applying a thick resin layer (e.g., between about 3 mm and 7 mm), the application can employ heated, plural systems wherein the parts are mixed in-line prior to being applied.

In some applications, solvent(s) can also be added to one or both parts being mixed, or to the mixed product. The mixed product/solvent composition can then be spray-applied, such as through a conventional “single-leg” paint sprayer or other spray-methods known to those skilled in the art of “paint spraying”. A preferred method is airless spray. Preferred solvents are organic chemicals and can contain aliphatic, aromatic, ketone, ether, and/or hydroxyl functionality.

A mesh is applied to or between the resin layer(s) to reinforce the composition. The use of a mesh provides reinforcement of the char once it starts to form. The mesh can reduce the chance that the coating will crack or fissure. Fissures reduce the protection provided by the coating because a fissure exposes the substrate and allows heat to more readily reach the substrate. The use of a mesh reduces the depth, length, width or combinations thereof for any fissures formed.

The mesh can be selected from meshes known to one skilled in the art that are used in intumescent compositions. The mesh can be selected from known high-temperature-stable meshes and can be made from fibers/strands of metal, glass, oxidized carbon or refractory inorganics. Examples are Zoltek PX3OFS08X4-COAT (Panex 30: Scrim Fabric 8×4 Coated) mesh, HK-1 from Internationa Paint, and IR-107 available from Intumescents Associates Group.

The mesh can be made using fibrous materials, such as high-temperature-stable polymers, class, inorganic oxides, carbon, and graphite fibers. Fibers containing carbides, such as silicon carbide or titanium carbide; borides, such as titanium diborides; oxides, such as alumina or silica; or ceramic can be used. The fibers can be used in the form of monofilaments, multifilaments, tows or yarns. In different embodiments, the mesh can contain high temperature fibers, a welded wire mesh, or combinations thereof.

The amount and properties of the mesh, such as density, size of fibers, flexibility, and ability to retain tensile strength at high temperatures are those known to those skilled in the art, represented by the Undewriters Laboratory 1709 designs for Carboline Type 440, Thermo-Lag 2000, Thermo-Lag 3000, Pitt-Char XP, Pitt-char XP2, Firetex M90, Firetex M93, Chartek 4, Chartek 7, and Chartek 1709.

An adhesive is applied substantially on one surface of the reinforcement mesh and is used to hold, or secure, the mesh onto the first resin layer. The adhesive can be applied prior to or at the time of spraying the epoxy intumescent layers. For example, the mesh can be obtained in roll form, with adhesive on substantially one side of the mesh. The adhesive can be an adhesive known to one skilled in the art of bonding together porous and/or non-porous surfaces. In one embodiment, the adhesive can be selected from the following types (or chemistries) consisting of rubbery polymers (often dissolved in organic solvents for ease of application), water-based latex polymers, cyanoacrylates, polyurethanes, and silicones. In one embodiment, the adhesive can be a rubbery solid. The rubbery solid can be soluble in an organic solvent. In another embodiment, the adhesive is a polymer. The polymer can be capable of being supplied as a water-based emulsion.

In one embodiment, the adhesive is a one-part system. A one-part system is faster and easier to apply. A multiple part system, e.g., two-part system, is slower and more difficult to apply. For example, in most multiple part systems, the parts must be combined shortly before application. In some embodiments, the one-part adhesive has a different chemical make-up as compared to the epoxy resins used for the intumescing layers. The epoxy resins are generally two-part, curing systems. In spite of the differing chemistries between the mesh adhesive and the epoxy resin, the use of one-part adhesives in the compositions of the present disclosure are effective before and during exposure to high temperatures.

The length of time it takes for the adhesive to initiate or start to effectively hold the mesh in place (e.g., without being held in place by the applicator or other means) is relatively short. For example, the adhesive can initiate holding the mesh in place (i.e., on the first resin layer) after about 1 second, about 2 seconds, about 5 seconds, about 10 seconds, about 30 seconds, about 1 minute, about 2 minutes, or for 5 minutes. These times can also be used to describe ranges of time it can take for the adhesive to initiate holding the mesh in place, such as from about 1 second to about 30 seconds, or any similar range.

The length of time the adhesive holds the mesh in place is sufficient to allow a second layer of resin material to be applied to the first mesh-resin layer with the mesh still in place. Preferably this time is greater than 30 seconds, more preferably greater than 60 seconds and more preferably greater than 5 minutes. In some embodiments, the adhesive can hold the mesh in place (e.g., on the first resin layer) for about 30 seconds, about 1 minute, about 2 minutes, about 5 minutes, about 10 minutes, about 30 minutes, or for about 1 hour or more. These times can also be used to describe ranges of time the mesh can be held in place, such as from about 30 seconds to about 30 minutes, or any similar range.

The adhesive can be applied substantially to one surface of the reinforcement mesh by known techniques. In one embodiment, the adhesive can be spray-applied. The adhesive can be applied to certain sections of the mesh (only one side) and other sections of the mesh can have no adhesive applied. Thus, a non-continuous layer of adhesive can be applied to the mesh. Of note, there can be some direct contact of adjacent resin layers, through or around the mesh.

The amount of adhesive used to hold or secure the mesh may vary. In one embodiment, the amount of adhesive in the multi-layer composition is less than 1%. More particularly, the amount of adhesive in the composition can be less than 0.1%.

The thickness of the adhesive applied substantially to one surface of the reinforcement mesh prior to the mesh application can vary. In particular, the thickness of the adhesive applied to only one surface of the mesh can be less than 20 mils, 15 mils, 10 mils, 8 mils, 5 mils, 3 mils, 2 mils or 1 mil. These values can also define a range of adhesive thickness, such as between about 1 mil and 3 mils.

The intumescent composition of the present disclosure can be used to protect a variety of substrates. In one embodiment, the intumescent composition of the present disclosure can be used to protect a substrate having edges or sides wherein the edges or sides are more difficult to protect using non-mesh containing intumescent compositions and, therefore, are more susceptible to damage from high temperature environments. Any surface, including rectangular or round columns/beams or flat areas can require mesh to stabilize the char because epoxy-intumescent char can shrink under the high heat. The type of material to be protected can include metal, wood and foamed, solid polymeric materials or paper in need of a thermal barrier against the effects of overheating and/or burning. The metals can include aluminum, iron, and steel. The substrate to be protected can be in the form of an I-beam (e.g., steel I-beam), a wide flange column, a round column or a rectangular column. Substrates of larger area can also be protected. Examples are walls, ceilings, floors and insulated material.

The first, second or both resin layers can swell as a result of heat exposure. The degree of swelling can vary depending on the level and rate of heat exposure and/or the composition of the layers and the like.

The intumescent composition of the present disclosure can extend the time it takes for a substrate to reach its critical failure temperature. For example, the intumescent composition of the present disclosure can extend the time it takes for steel to reach its critical failure temperature (e.g., 550° C.) under standard test conditions. In one embodiment, the intumescent composition of the present disclosure can result in the time it takes for a substrate to reach is critical failure temperature to be 15-300 minutes. Particular values are 30, 60, 75, 120, 150, or 240 minutes.

The present disclosure also relates to a method of applying an intumescent composition, as described herein, onto a substrate, the method comprising applying a first epoxy resin layer containing a first intumescent material to a substrate, applying an adhesive substantially on one surface of a reinforcement mesh, applying the reinforcement mesh to the first epoxy resin layer with the applied adhesive layer directed toward the first epoxy resin layer, and applying a second resin layer containing a second or the same intumescent material over the reinforcement mesh to form an intumescent multi-layer composition. The first and second epoxy resin layers containing intumescent materials swell as a result of heat exposure.

The first and second resin layers can be applied by known techniques. In addition, the adhesive may be applied to only one surface of the mesh by known techniques. In particular, the first and second resin layers can be applied by spray, trowel, brush and by similar means. The adhesive can be applied substantially to one surface of the mesh by a roller, by a brush, or can be spray-applied.

The mesh with adhesive applied substantially on one surface thereof can be applied to the first epoxy resin layer by known techniques. In particular, the mesh can be applied manually or mechanically by pressing or holding the mesh in or onto the first resin layer with the adhesive substantially on one surface of the mesh oriented toward the first epoxy resin layer. In one embodiment, the mesh can be applied without the use of a solvent to assist in attaching or embedding the mesh into the resin layer (e.g., the composition is solvent-free). The mesh can also be applied as separate pieces over the first resin layer—with adhesive applied substantially on one surface and that surface being oriented toward the first resin layer. For example, the mesh (with adhesive applied substantially on one surface) can be applied as separate pieces around the first layer on the substrate, particularly around each tip of an I-beam or column—each piece being applied with the adhesive oriented toward the first resin layer.

Traditionally, the mesh is applied to the first epoxy resin/intumescent layer during the cure time. Thus, in conventional applications, the mesh is contacted to this first layer and embedded into this layer. Embedding the mesh, however, is not trivial. In conventional applications, the mesh must be embedded after the resin layer has hardened or cured enough to accept the mesh and hold the mesh in place after embedding. The noted hardening can occur via solvent evaporation, cooling, curing, viscosity increase due to the absence of movement (versus the reduced viscosity generated during spray), and the like. That is, in conventional applications, the viscosity must be low enough to allow the mesh to penetrate the un-hardened or partially-hardened layer. The mesh cannot be embedded in conventional applications after the resin layer has cured too much such that the force applied to embed the mesh damages the resin layer, results in insufficient embedding, weak attachment or is too burdensome for the applicator. At the same time, the viscosity must be high enough in conventional applications such to allow the mesh to be pushed into the epoxy material without excessive deformation of either the layer or the mesh. Because hardening times for different suitable resin-intumescent materials vary, correct application of the mesh in conventional applications is often incorrect or non-ideal. The present disclosure provides a method, and resulting composition, that eliminates or reduces these issues, and avoids undesirable adhesive fouling of the roller used to secure the mesh relative to the first resin layer. The methods and compositions of the present disclosure are applicable to substantially all suitable epoxy resin -intumescent materials regardless of rate of hardening.

The mesh with adhesive applied substantially on one surface thereof can be applied before the first epoxy resin/intumescent layer is substantially cured. The mesh with adhesive substantially on one surface thereof can also be applied after this layer is substantially cured such that the mesh will not adhere to the resin layer in the absence of the adhesive. The mesh with adhesive substantially on one surface thereof can be applied immediately after the first resin layer is applied (or has sufficient viscosity to support such application), or after 1 minute, 2 minutes, 5 minutes, 10 minutes, 20 minutes, 30 minutes, 1 hour, 2 hours, 4 hours, 8 hours, 16 hours, 1 day, 2 days, 1 week, or longer. These times can also define a range of when the mesh with adhesive applied to only one surface thereof can be applied to the first resin layer, such as between 10 minutes and 1 week. The capability of adding the mesh after the first layer is substantially cured can be of great benefit. In some cases it can be most convenient to apply the mesh on a day subsequent to the application of the first epoxy intumescent layer. An example of this is when the application is finished at the end of a workday.

Prior to the application of the intumescent composition of the present disclosure, the substrate can be primed with a primer (e.g., presenting a primed surface to which epoxy intumescent materials are applied). The substrate can also be an un-primed substrate (e.g., the intumescent composition is applied directly onto the substrate.). Some advantages of a primer are corrosion inhibition and enhanced adhesion to the substrate. The primer is preferably non-aqueous, and more preferably an epoxy primer, but could be water based. Similarly, a substrate coated with an intumescent composition of the present disclosure may further be coated with a top coat on top of the intumescent composition. A top coat can provide additional durability to physical or environmental challenges. In particular, topcoats can provide protection against abrasion, impact, chemicals, water, temperature extremes and sunlight.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

In Examples 1-3, W8×28 columns with a height of 16 inches were used. The steel surfaces were cleaned with a wire brush powered by a hand drill, followed by wiping down with water and then air drying. Thermocouples were put 5 mm deep into the steel at mid height and 25 mm from each flange tip. By averaging the temperatures of the thermocouples on a single flange, two different materials or different modes of mesh attachment can be evaluated in a single fire test (to be described later). Each inner flange, outer flange, and tip were uniformly trowel-coated with a layer of commercially available epoxy-intumescent product, Nanochar from Intumescent Associates Group. The total amount used for each flange was 720 grams. Note that the column webs were not coated.

After 4 hours of curing at approximately 72° F. , three methods of mesh application were used. Either the mesh was applied using known techniques (Example 1; control 1), the mesh was applied by first spraying the epoxy-coated surfaces with adhesive (Loctite, 300 Heavy, from Henkel Corporation, One Henkel Way, Rocky Hill, Conn. 06067), followed by light pressure to attach the mesh (Example 2; control 2), or the mesh was applied by spraying adhesive onto only one side of the mesh, followed by attaching the mesh to the epoxy-coated surfaces, with light pressure, on mesh surfaces that had not been sprayed with adhesive. The surface onto which the adhesive had been sprayed was oriented toward the epoxy surface (Example 3; the composition/method of the present invention). In each example, a second coat of the same amount of the same material as the first layer was then applied to all mesh-containing surfaces.

The mesh used in these examples was a Zoltek PX3OFS08X4-COAT (Panex 30: Scrim Fabric 8×4 Coated) mesh.

After allowing the coatings to fully cure at a minimum of 12 hours at 140° F., the columns were cooled to approximately 72° F., and 1″ of high-temperature-stable fiber insulation was placed in immediate contact with all web surfaces. The columns were then tested in a high-temperature furnace. The time/temperature profile of the furnace followed the UL 1709 standard. When the average column temperature reached 1000° F., the test was ended. Longer times to this test end indicate better performance. The precision of each test was found to be approximately +2° F., therefore if two tests are within 4 minutes, they are considered equivalent.

### Example 1-Control 1

In this example, the common method utilized in the field was used. Mesh was embedded into the first layer of epoxy intumescent prior to applying the second epoxy intumescent layer, approximately 3 hours after application of the first layer. A piece of mesh 16 inches high was wrapped around each flange, starting at the intersection of a web and an inner flange and continuing around the tip/outer flange/tip, to the other inner flange/web intersection of the same flange. The first layer of epoxy intumescent was not fully cured at the time that the mesh was applied. Penetration of the partially cured epoxy was accomplished by pressure supplied by an acetone soaked “paint-type” roller. After additional curing of the epoxy, the second coat of epoxy intumescent was applied.

The fire test described above was run on this column to an end point of 40 minutes.

### Example 2-Adhesive Applied to the Surface of the First Layer (Control 2)

In this example, adhesive (Loctite, 300 Heavy, from Henkel Corporation, One Henkel Way, Rocky Hill, Conn. 06067) was applied to the surface of the first epoxy layer prior to mesh application. Approximately 4 hours after application of the first layer, a light coating of adhesive was sprayed on the first layer of epoxy intumescent. After a few seconds, a piece of mesh 16 inches high was wrapped around each flange, starting at the intersection of a web and an inner flange and continuing around the tip/outer flange/tip, to the other inner flange/web intersection of the same flange. Light pressure was applied to all surfaces that had the mesh thereon. Although this worked, the surfaces between the mesh strands were sticky, making the overall process more difficult more difficult than in the next example. The second coat of epoxy intumescent was then applied.

The fire test described above was run on this column to an end point of 44 minutes.

### Example 3-Adhesive Applied to One Surface of the Mesh

In this example—which corresponds to the present invention—adhesive (Loctite, 300 Heavy, from Henkel Corporation, One Henkel Way, Rocky Hill, Conn. 06067) was applied substantially to one surface of the mesh, prior to its attachment to the epoxy intumescent surface. Approximately 4 hours after application of the first layer, a light coating of adhesive was sprayed onto one surface of the mesh. After a few seconds, this piece of mesh was wrapped around each flange, 16″ high and starting at the intersection of a web and an inner flange and continuing around the tip/outer flange/tip, to the other inner flange/web intersection of the same flange, with the adhesive-bearing surface oriented toward the epoxy resin layer. Light pressure was applied to all surfaces that had the mesh thereon. This method was quick, easy and effective. The second coat of epoxy intumescent was then applied.

The fire test described above was run on this column to an end point of 44 minutes.

Example 3 was preferable as compared to the other two Examples because the application of the mesh was effective, quick and easy (without fouling caused by the adhesive), and the methodology removed the criticality of timing for application of the mesh to the first resin layer.

While this disclosure has been particularly shown and described with reference to example embodiments thereof, it will be understood by those skilled in the art that various changes in form and details may be made therein without departing from the scope of the invention encompassed by the appended claims.

We claim:

1. An intumescent composition comprising:
(i) a first epoxy resin layer including an intumescent material;
(ii) a mesh with an adhesive applied substantially to one surface of the mesh, the adhesive-bearing surface being oriented toward and in contact with the first epoxy resin layer; and
(iii) a second epoxy resin layer including intumescent material applied to the mesh-containing first resin layer.

2. The intumescent composition of claim 1, wherein the intumescent material is selected from the group consisting of ammonium polyphosphate, melamine pyrophosphate, ethylenediamine phosphate, boric acid, limestone, titania, mineral solids, ceramic solids, glass solids, fibers, phosphate esters, borates, silica, melamine, tris(hydroxyethyl) isocyanurate, clays, polyhydroxy organic chemicals, carbon, expanded graphite, benzyl alcohol, alumina, phenols, polysulfides, and tris(dimethylaminomethyl)phenol.

3. The intumescent composition of claim 1, wherein the adhesive is comprised of a rubbery solid and an organic solvent.

4. The intumescent composition of claim 1, wherein the adhesive is a polymer contained in a water-based emulsion.

5. The intumescent composition of claim 1, wherein the mesh includes carbon, glass, refractory inorganics, or mixtures thereof.

6. The intumescent composition of claim 1, wherein adhesive is in the form of a non-continuous layer.

7. An article comprising a substrate with edges or sides, wherein the substrate is coated with an intumescent composition of claim 1.

8. The article of claim 7, wherein the substrate includes steel.

9. The article of claim 7, wherein the substrate is an I-beam, a wide flange column, a round column or a rectangular column.

10. A method comprising:
(i) applying a first epoxy resin layer including intumescent material to a substrate;
(ii) applying an adhesive substantially to one surface of a mesh;
(iii) applying the mesh to the first epoxy resin layer with the adhesive-bearing surface of the mesh oriented toward the first epoxy resin layer; and
(iv) applying a second epoxy resin layer including intumescent material to the mesh-containing first epoxy resin layer.

11. The method of claim 10, wherein the adhesive is applied substantially to one surface of the mesh by a roller, by a brush, or is spray-applied.

12. The method of claim 10, wherein the first resin layer is substantially cured prior to the application of the adhesive-bearing mesh.

13. The method of claim 10, wherein the adhesive is comprised of a rubbery solid and an organic solvent.

14. The method of claim 10, wherein the adhesive is a polymer contained in a water-based emulsion.
